(19) United States
(12) Patent Application Publication
(10) Pub. No.: US 2022/0379455 A1
(43) Pub. Date: Dec. 1, 2022

(54) ELECTRIC POWER TOOL

(71) Applicant: Koki Holdings Co., Ltd., Tokyo (JP)

(72) Inventor: Kohei WAKITA, Ibaraki (JP)

(21) Appl. No.: 17/772,944

(22) PCT Filed: Sep. 25, 2020
(86) PCT No.: PCT/JP2020/036448

§ 371 Date: Apr. 28, 2022

(30) Foreign Application Priority Data
Oct. 31, 2019 (JP) 2019-198182

(51) Int. Cl. B25F 5/02; H02K 5/173; H02K 7/08; H02K 7/14

(52) U.S. Cl. CPC B25F 5/02; H02K 5/1732; H02K 7/083; H02K 7/145

(57) ABSTRACT

An electric power tool is a hammer drill including an electric motor having a rotating shaft configured to rotate by electric power, a housing including the electric motor, and cords for supplying power to the electric motor. The housing includes a first component and a second component divided in a crossing direction intersecting an axial direction of the rotating shaft, and the first component has an opening that is open in the crossing direction. The electric motor is between the first component and the second component in the crossing direction. The second component is attached to the opening. A tubular portion formed integrally with the first component and configured to support the electric motor is provided, and a wire arrangement portion between the first component and the tubular portion and having a region that overlaps with the tubular portion and invisible when viewed from the opening is further provided.

### TECHNICAL FIELD

The present invention relates to an electric power tool having an electric motor and a housing in which the electric motor is housed.

### BACKGROUND ART

Patent Document 1 describes an example of an electric power tool having an electric motor and a housing in which the electric motor is housed. The electric power tool described in Patent Document 1 is a hammer drill, and the hammer drill has a motor housing as a housing, a handle connected to the motor housing, and an electric motor housed in the motor housing. The electric motor has an output shaft as a rotating element. A weight housing is attached to the motor housing. Further, a first intermediate shaft and a second intermediate shaft are provided in the weight housing.

A power cable is attached to the handle, and a trigger and a switch mechanism are provided on the handle. The power cable connects the switch mechanism to an external power supply. By the operation of the trigger by a worker, the switch mechanism and the power supply are connected and disconnected. When the switch mechanism is connected to the power supply and the output shaft of the electric motor rotates, the rotational force of the output shaft is transmitted to the second intermediate shaft via the first intermediate shaft.

### RELATED ART DOCUMENTS

### Patent Documents

Patent Document 1: Japanese Unexamined Patent Application Publication No. 2014-24171

### SUMMARY OF THE INVENTION

### Problem to be Solved by the Invention

The inventor of this application has recognized the problem that the size of the housing increases in an axial direction of a rotating element depending on the position where an electric wire for supplying electric power of a power supply to an electric motor is arranged in the housing.

An object of the present invention is to provide an electric power tool capable of suppressing the increase in size of the housing in an axial direction of a rotating element.

### Means for Solving the Problems

An electric power tool according to an embodiment is an electric power tool including: an electric motor having a rotating element rotated by electric power supplied thereto; a housing configured to house the electric motor therein; and an electric wire provided in the housing and configured to supply electric power to the electric motor. The housing includes a first component and a second component divided in a crossing direction intersecting an axial direction of the rotating element, the first component has an opening that is open in the crossing direction, and the electric motor is housed between the first component and the second component in the crossing direction in a state where the second component is attached to the opening. The electric power tool further includes: a holder formed integrally with the first component and configured to support the electric motor; and a wire arrangement portion provided between the first component and the holder and having a region that is overlapped with the holder and invisible when viewed from the opening.

### Effects of the Invention

According to the present invention, a region in which an electric wire is arranged and a region in which a holder is arranged can be overlapped in an axial direction of a rotating element. Therefore, it is possible to suppress the size of the housing from increasing in the axial direction of the rotating element.

### BRIEF DESCRIPTION OF THE DRAWINGS

FIG. 1 is a front cross-sectional view showing a hammer drill which is an embodiment of an electric power tool of the present invention;

FIG. 2 is a front cross-sectional view showing the inside of a gear case of the hammer drill;

FIG. 3 is a front cross-sectional view showing the inside of a housing of the hammer drill;

FIG. 4 is a schematic diagram showing an electric circuit provided in the hammer drill;

FIG. 5 is a plan view showing the housing of FIG. 3 in an exploded manner;

FIG. 6 is a schematic perspective view of a holder provided in the housing;

FIG. 7 is a front view showing a first component which is a part of the housing;

FIG. 8 is a perspective view showing the housing in an exploded manner;

FIG. 9 is a right side view showing the housing in an exploded manner;

FIG. 10 is a right cross-sectional view of the first component taken along a line II-II shown in FIG. 7;

FIG. 11(A) is a front cross-sectional view showing a molding die for producing the first component;

FIG. 11(B) is a right side view of FIG. 11(A);

FIG. 12(A) is a bottom cross-sectional view taken along a line III-III in FIG. 11(B);

FIG. 12(B) is a bottom cross-sectional view taken along a line IV-IV in FIG. 11(B);

FIG. 13(A) is a right cross-sectional view taken along a line V-V in FIG. 11(A); and

FIG. 13(B) is a right cross-sectional view taken along a line VI-VI in FIG. 11(A).

### DETAILED DESCRIPTION OF PREFERRED EMBODIMENTS

A hammer drill which is an embodiment of an electric power tool of the present invention will be described below with reference to drawings.

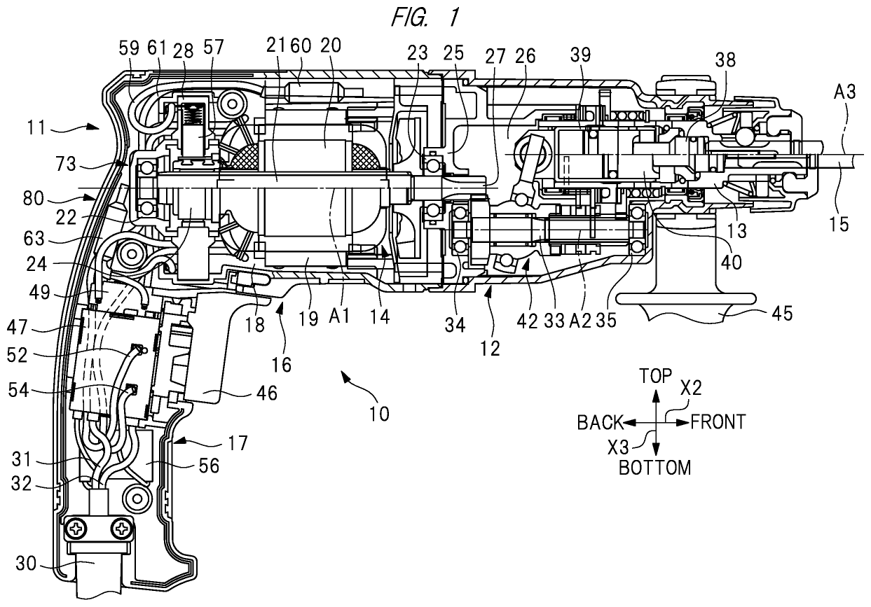

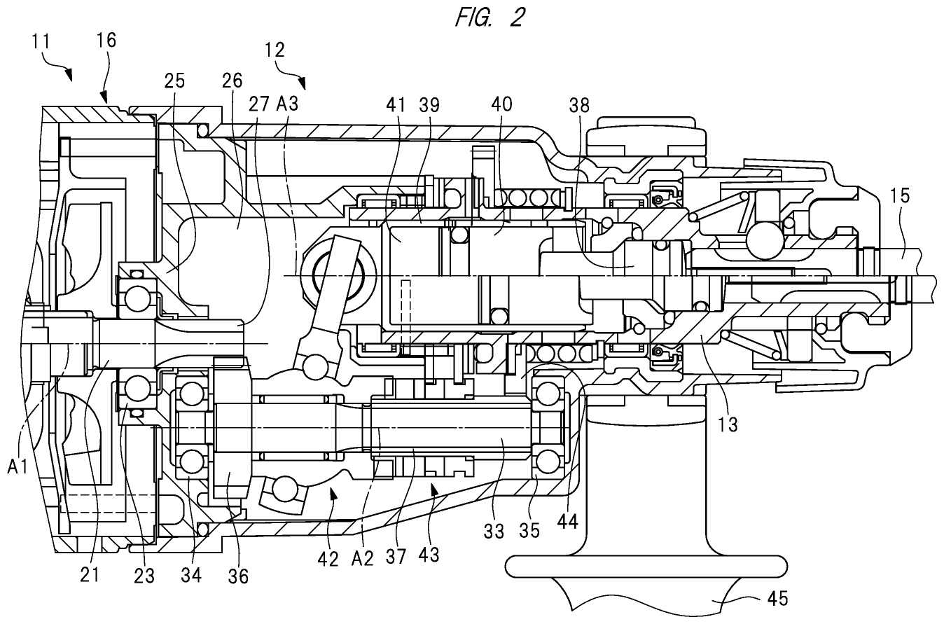

A hammer drill 10 shown in FIG. 1 includes a housing 11, a gear case 12, a cylinder 13, and an electric motor 14. The cylinder 13 can support a tool 15. The hammer drill 10 has a function of rotating the tool 15 by the power of the electric motor 14 and a function of applying a striking force to the tool 15 by the power of the electric motor 14.

The housing 11 has a motor housing 16 and a handle 17. A first housing chamber 18 is provided in the motor housing 16, and the electric motor 14 is housed in the first housing chamber 18. The electric motor 14 has a stator 19 fixed to the motor housing 16 and a rotatable armature 20. The armature 20 has a coil of conductive wires, and the armature 20 is attached to a rotating shaft 21. The rotating shaft 21 is rotatably supported by two bearings 22 and 23 about a rotation center line A1. The two bearings 22 and 23 position the rotating shaft 21 in the radial direction about the rotation center line A1 and in the direction along the rotation center line A1. In FIG. 1, the direction along the rotation center line A1 can be defined as the front-back direction X2.

The stator 19 is arranged outside the armature 20 in the radial direction about the rotation center line A1. There is a gap in the radial direction of the rotating shaft 21 between the armature 20 and the stator 19. Further, a commutator 24 is provided on the rotating shaft 21. The commutator 24 switches the direction of current between an AC power supply 48 and the armature 20. In the armature 20, an electric current flows to form a magnetic field. The commutator 24 and the armature 20 are arranged side by side in the direction along the rotation center line A1. Further, the two bearings 22 and 23 are arranged at an interval in the direction along the rotation center line A1. The commutator 24 and the armature 20 are arranged between the bearing 22 and the bearing 23 in the direction along the rotation center line A1. The commutator 24 is arranged between the bearing 22 and the armature 20 in the direction along the rotation center line A1. Further, the rotating shaft 21 has an output gear 27.

The handle 17 is connected to the motor housing 16. FIG. 1 shows an example in which the handle 17 is arranged along the vertical direction X3 intersecting the rotation center line A1. The vertical direction X3 coincides with the direction of action of gravity on the premise that the rotation center line A1 is substantially horizontal. The gear case 12 is fixed at a portion of the motor housing 16 opposite to the portion where the handle 17 is connected in the direction along the rotation center line A1. The motor housing 16 and the gear case 12 are fixed by a fixing element, for example, a screw member.

The gear case 12 has a tubular shape, and a partition wall 25 is provided in the gear case 12. The partition wall 25 separates the first housing chamber 18 from a second housing chamber 26 of the gear case 12. The bearing 23 is supported by the partition wall 25. An end portion of the rotating shaft 21 in the direction along the rotation center line A1 is arranged in the second housing chamber 26. The output gear 27 is provided on the rotating shaft 21 at a position arranged in the second housing chamber 26.

Further, a brush holder 28 made of an insulating material, for example, a synthetic resin, is provided in the housing 11. The brush holder 28 is arranged in the first housing chamber 18. The brush holder 28 is arranged outside the rotating shaft 21 in the radial direction of the rotating shaft 21. The brush holder 28 supports a plurality of brushes, for example, brushes 57 and 58, and the brushes 57 and 58 are in contact with the outer peripheral surface of the commutator 24, respectively. The brushes 57 and 58 connect the AC power supply 48 and the commutator 24 so as to make them electrically conductible. As described above, the electric motor 14 can be defined as a brushed motor.

A power cable 30 is attached to a portion of the handle 17 opposite to the portion connected to the motor housing 16. The power cable 30 is connected to an AC power supply. The power cable 30 is configured by covering two cords 31 and 32 with an insulating material. The two cords 31 and 32 are connected to the brushes 57 and 58 via an electric circuit. Current flows through the two cords 31 and 32.

An intermediate shaft 33 is provided in the second housing chamber 26. The intermediate shaft 33 is an element that transmits the power of the rotating shaft 21 to the tool 15. Two bearings 34 and 35 are provided in the second housing chamber 26. The intermediate shaft 33 is rotatably supported about a rotation center line A2 by the two bearings 34 and 35. The rotation center line A2 is parallel to the rotation center line A1, and the rotation center line A1 is arranged non-coaxially with the rotation center line A2. Of the both ends of the intermediate shaft 33 in the longitudinal direction, a gear 36 is fixed to an end of the intermediate shaft 33 closer to the partition wall 25. The gear 36 rotates together with the intermediate shaft 33, and the gear 36 is meshed with the output gear 27. Further, a gear 37 is provided on the intermediate shaft 33.

The cylinder 13 is provided in the second housing chamber 26. The cylinder 13 is arranged across the second housing chamber 26 and the outside of the gear case 12. The cylinder 13 can rotate about a rotation center line A3. The rotation center line A3 is parallel to the rotation center lines A1 and A2, and the rotation center line A3 is arranged eccentrically with respect to the rotation center lines A1 and A2.

The tool 15 is supported by the cylinder 13. The tool 15 and the cylinder 13 do not rotate relative to each other, and the tool 15 can move within a predetermined range in the direction along the rotation center line A3 with respect to the cylinder 13. A second hammer 38 is provided so as to be movable in the cylinder 13 in the direction along the rotation center line A3.

A piston 39 is arranged in the cylinder 13. The piston 39 can move in the direction along the rotation center line A3 with respect to the cylinder. The piston 39 has a tubular shape. A striker 40 is arranged in the piston 39. The striker 40 can move in the direction along the rotation center line A3 with respect to the piston 39. A pressure chamber 41 is provided in the piston 39. The striker 40 is biased toward the second hammer 38 by the pressure of the pressure chamber 41.

A conversion unit 42 is provided in the second housing chamber 26. The conversion unit 42 has, for example, a cam mechanism, and the conversion unit converts the rotational force of the intermediate shaft 33 into the linear force of the piston 39. Further, a clutch 43 is provided in the second housing chamber 26. A mode switching lever is provided in the housing 11, and when the worker operates the mode switching lever, the clutch 43 is actuated. The clutch 43 connects and disconnects the power transmission path between the intermediate shaft 33 and the conversion unit 42. A gear 44 is attached to the cylinder 13, and the gear 44 is meshed with the gear 37. A grip 45 is attached to the gear case 12, and the user grasps the grip 45 with a hand.

A trigger 46 is provided on the handle 17. The trigger 46 is arranged at a position closest to the motor housing 16 in the direction in which the handle 17 protrudes from the motor housing 16. The trigger 46 can be actuated from an initial position with respect to the handle 17 in the direction along the rotation center line A1. When an operating force on the trigger 46 is released, the trigger 46 is stopped at the initial position. When the user applies an operating force to the trigger 46, the trigger 46 is actuated from the initial position. Note that, when the operating force on the trigger 46 is released, the trigger 46 returns and stops at the initial position by the force of the spring. Further, a speed change switch 47 is provided in the handle 17. The speed change switch 47 is an element that changes the rotation speed of the electric motor 14 in accordance with the amount by which the trigger 46 is actuated from the initial position.

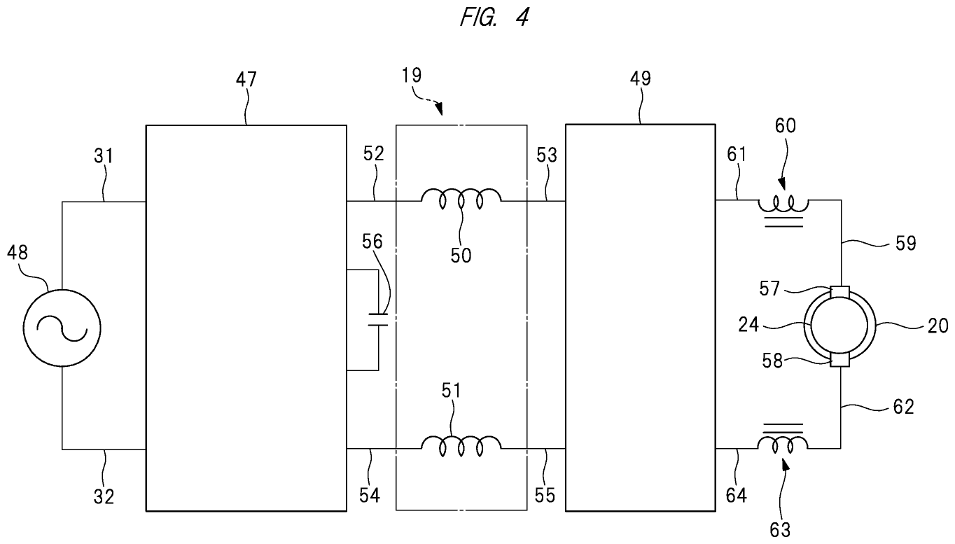

FIG. 4 shows an electric circuit that supplies electric power from the AC power supply 48 to the electric motor 14. When the power cable 30 is connected to the AC power supply 48, the AC power supply 48 and the speed change switch 47 are connected by the two cords 31 and 32. A changeover switch 49 that changes the rotation direction of the electric motor 14 is provided in the housing 11. The stator 19 has conductive coils 50 and 51 arranged in parallel. A first end of the coil 50 is connected to the speed change switch 47 by a cord 52, and a second end of the coil 50 is connected to the changeover switch 49 by a cord 53. A first end of the coil 51 is connected to the speed change switch 47 by a cord 54, and a second end of the coil 51 is connected to the changeover switch 49 by a cord 55. Further, a capacitor 56 is connected to the speed change switch 47.

The brush 57 is connected to the changeover switch 49 via a cord 59, a choke coil 60, and a cord 61. The brush 58 is connected to the changeover switch 49 via a cord 62, a choke coil 63, and a cord 64. These cords 52, 53, 54, 55, 59, 61, 62, and 64 are arranged in the first housing chamber 18 or the handle 17. Current flows through the cords 52, 53, 54, 55, 59, 61, 62, and 64, respectively.

An example of using the hammer drill 10 will be described. First, the user grasps the grip 45 with the first hand, grasps the handle 17 with the second hand, and presses the tool 15 to a target object. When the user applies an operating force to the trigger 46, electric power is supplied from the AC power supply 48 to the electric motor 14, a magnetic field is generated between the stator 19 and the armature 20, and the rotating shaft 21 rotates. The rotational force of the rotating shaft 21 is transmitted to the intermediate shaft 33 via the gear 36. The rotational force of the intermediate shaft 33 is transmitted to the cylinder 13 via the gear 44, and the tool 15 rotates together with the cylinder 13.

The speed change switch 47 adjusts the rotation speed of the rotating shaft 21 of the electric motor 14 in accordance with the amount by which the trigger 46 is actuated from the initial position. When the actuated amount of the trigger 46 increases, the rotation speed of the rotating shaft 21 of the electric motor 14 increases. When the actuated amount of the trigger 46 decreases, the rotation speed of the rotating shaft 21 of the electric motor 14 decreases.

When a mode changeover switch is operated and the drill mode is selected, the clutch 43 does not transmit the rotational force of the intermediate shaft 33 to the conversion unit 42. Therefore, the piston 39 is stopped and no striking force is applied to the tool 15. On the other hand, when the mode changeover switch is operated and the hammer drill mode is selected, the clutch 43 transmits the rotational force of the intermediate shaft 33 to the conversion unit 42. Thus, the piston 39 reciprocates, and the pressure in the pressure chamber 41 rises. Therefore, the striker 40 is actuated and the second hammer 38 strikes the tool 15. Consequently, the tool 15 is rotated and receives a striking force.

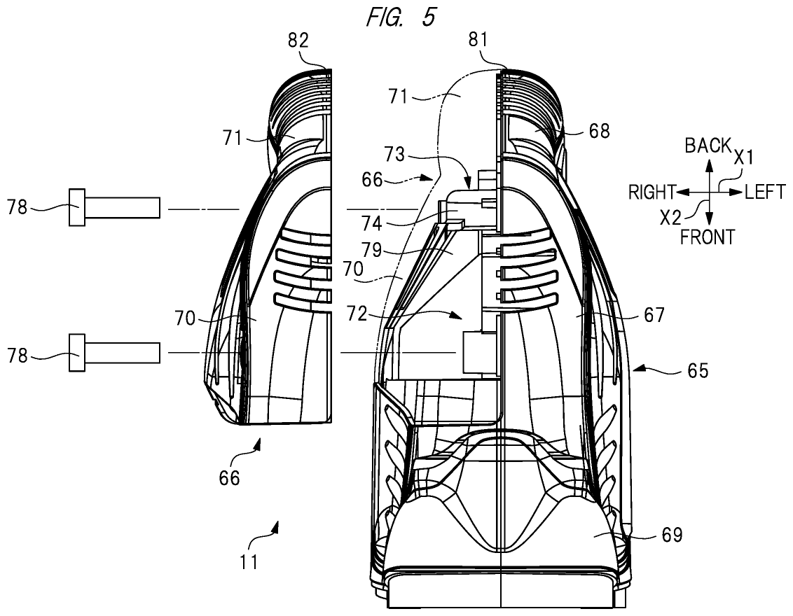

Next, the configuration of the housing 11 will be described. The housing 11 has a first component 65 and a second component 66 as shown in FIG. 5. The first component 65 and the second component 66 are physically separate members. The first component 65 and the second component 66 are each configured by covering the surface of the synthetic resin with synthetic rubber. The first component 65 and the second component 66 are fixed by fixing elements, for example, screw members 78.

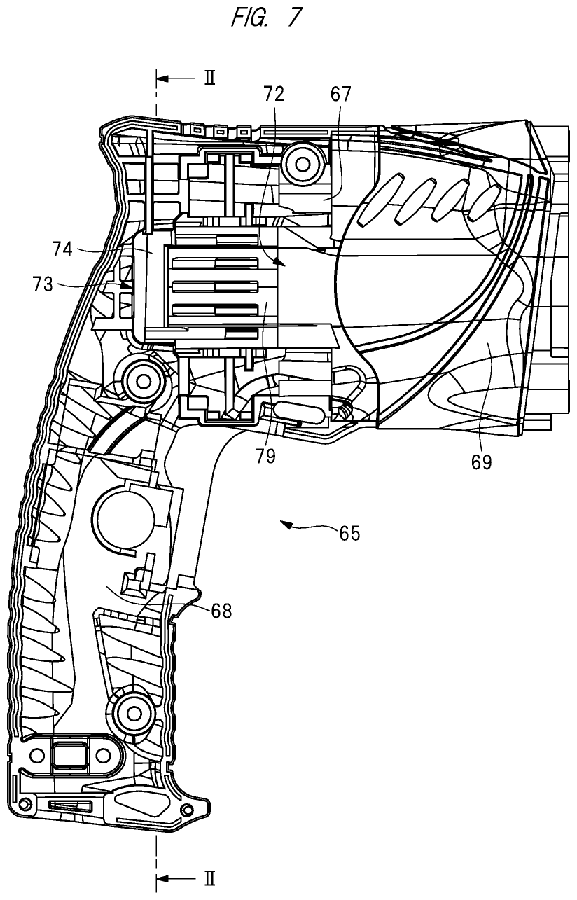

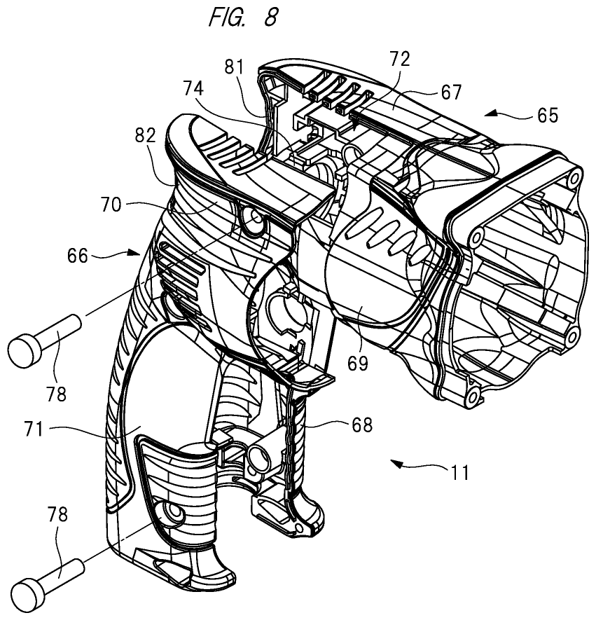

The first component 65 has a main body 67, a connection portion 68 connected to the main body 67, and a tubular portion 69 connected to the main body 67. The main body 67 is arranged on the back side of the tubular portion 69 in the direction along the rotation center line A1. In other words, the tubular portion 69 is arranged between the gear case 12 and the main body 67 in the direction along the rotation center line A1. The first component 65 has an opening 72 as shown in FIG. 5, FIG. 7, and FIG. 8. The opening 72 is formed over substantially the entire left side of the main body 67 shown in FIG. 5, and is open toward the left side. When the first component 65 is viewed in a plan view as in FIG. 5, the opening 72 connects the inside and the outside of the main body 67 in the left-right direction X1 intersecting the rotation center line A1.

When the housing 11 is viewed in a plan view as in FIG. 5, the left-right direction X1 intersects the rotation center line A1. The left and right in the left-right direction X1 are determined in a state where the housing 11 is viewed from the back side. Further, in the housing 11 shown in FIG. 5, the direction along the rotation center line A1 can be defined as the front-back direction X2.

The second component 66 has a main body 70 and a connection portion 71 connected to the main body 70. When the housing 11 is viewed in a plan view, the main body 67 and the connection portion 68 of the first component 65 and the main body 70 and the connection portion 71 of the second component 66 are divided into two with the rotation center line A1 as a boundary. The main body 70 is arranged at the same position as the main body 67 in the direction along the rotation center line A1. In other words, the main body 70 is arranged side by side on one side of the tubular portion 69 in the direction along the rotation center line A1. Namely, the main body 70 is arranged next to the tubular portion 69 in the direction along the rotation center line A1.

Also, the first component 65 and the second component 66 are fixed in a state where the main body 70 is in contact with the main body 67 and the tubular portion 69, thereby constituting the motor housing 16. The first housing chamber 18 is provided between the main body 67 and the main body 70 and across the inside of the tubular portion 69. Further, the second component 66 is fixed to the first component 65 so as to close the opening 72. The main body 70 of the second component 66 is in contact with the tubular portion 69, and the first housing chamber 18 is provided between the main body 70 of the second component 66 and the main body 67 of the first component 65. When the first component 65 and the second component 66 are fixed to each other, the electric motor 14 is arranged between the main body 67 and the main body 70 in the left-right direction X1. Further, the first component 65 and the second component 66 are fixed in a state where the connection portion 68 and the connection portion 71 are in contact with each other, thereby constituting the handle 17. The two brush holders 28 are sandwiched and supported by the first component 65 and the second component 66.

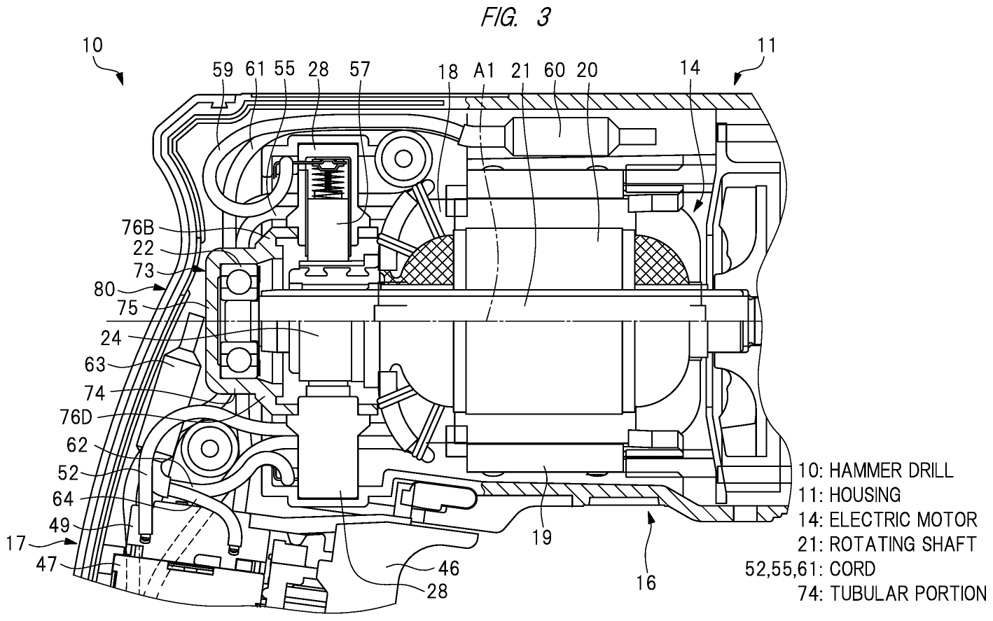

As shown in FIG. 3, a positioning portion 73 that supports the bearing 22 is provided in the housing 11. The positioning portion 73 is made of synthetic resin, and the positioning portion 73 and the first component 65 are formed as an integrally molded product. The positioning portion 73 is provided at a connection point between the motor housing 16 and the handle 17. The positioning portion 73 has a tubular portion 74 and a wall portion 75 provided at the end of the tubular portion 74 in the direction along the rotation center line A1. The tubular portion 74 is arranged outside the bearing 22 in the radial direction of the rotation center line A1. The positioning portion 73 and the tubular portion 69 are arranged at different positions in the direction along the rotation center line A1.

As shown in FIG. 5 and FIG. 7, a stay 79 connecting the tubular portion 74 and the tubular portion 69 is provided. The positioning portion 73 positions the bearing 22 in the direction along the rotation center line A1 and positions the bearing 22 in the radial direction of the rotation center line A1.

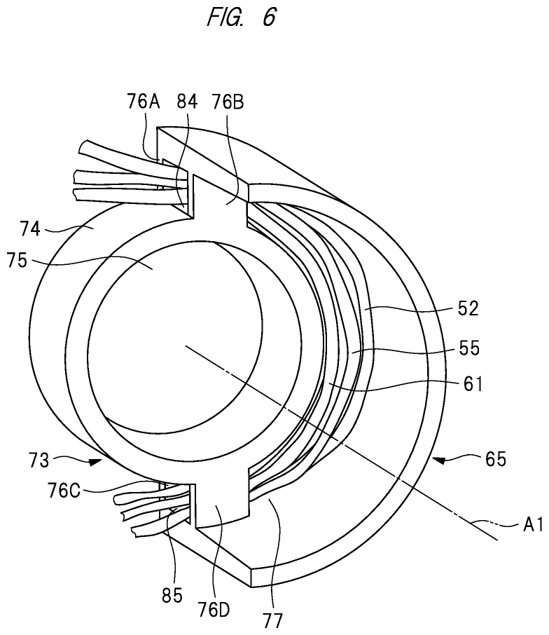

As shown in FIG. 6, ribs 76A, 76B, 76C, and 76D protruding in the radial direction of the rotating shaft 21 from the tubular portion 74 are provided. The rib 76A and the rib 76B are arranged at the same position in the circumferential direction of the tubular portion 74, and are arranged at different positions in the direction along the rotation center line A1. The ribs 76A and 76B are connected to the first component 65.

A passage 84 is provided between the rib 76A and the rib 76B. The passage 84 is surrounded by the wall surfaces of the ribs 76A and 76B, the tubular portion 74, and the main body 67. In other words, the passage 84 is a hole provided between the first component 65 and the tubular portion 74.

The rib 76C and the rib 76D are arranged at the same position in the circumferential direction of the tubular portion 74, and are arranged at different positions in the direction along the rotation center line A1. The ribs 76C and 76D are connected to the first component 65. A passage 85 is provided between the rib 76C and the rib 76D. The passage 85 is surrounded by the wall surfaces of the ribs 76C and 76D, the tubular portion 74, and the main body 67. In other words, the passage 85 is a hole provided between the first component 65 and the tubular portion 74.

The passage 84 is located above the tubular portion 74 in FIG. 6, and the passage 85 is located below the tubular portion 74. In other words, the passage 84 and the passage 85 are arranged at point-symmetrical positions about the rotation center line A1. As shown in FIG. 8, when the second component 66 is separated from the first component 65, the user can visually recognize the tubular portion 74 through the opening 72.

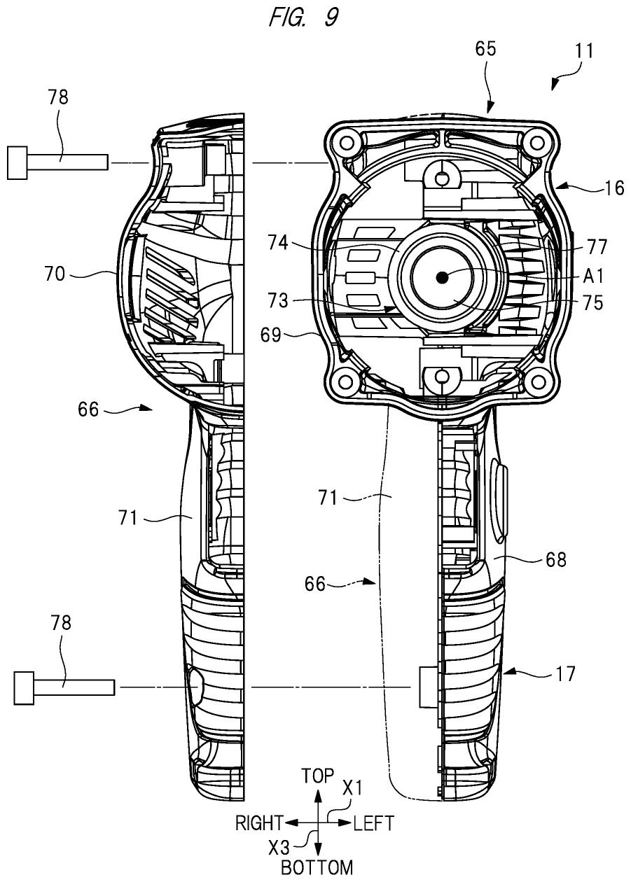

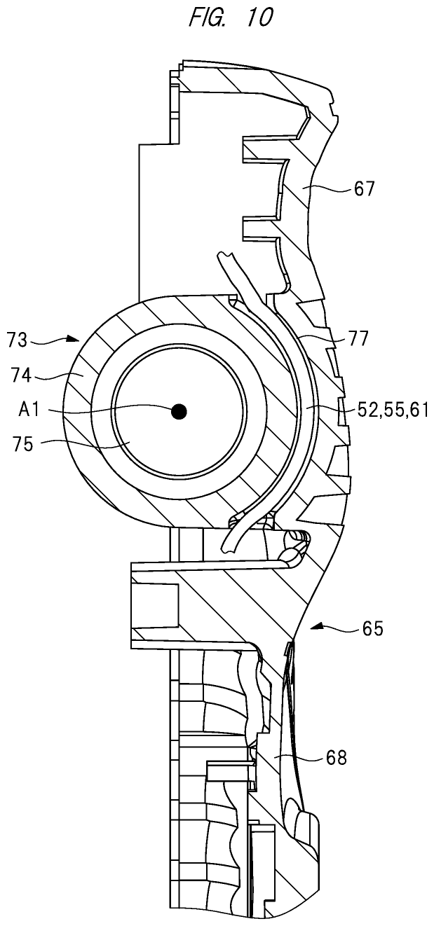

As shown in FIG. 3, the bearing 22 is arranged in the tubular portion 74, the wall portion 75 positions the bearing 22 in the direction along the rotation center line A1, and the tubular portion 74 positions the bearing 22 in the radial direction. Also, as shown in FIG. 9 and FIG. 10, an arrangement portion 77 is provided between the outer peripheral surface of the tubular portion 74 and the inner surface of the first component 65 in the radial direction of the circle centered on the rotation center line A1. The arrangement portion 77 is an arc-shaped space or gap. The arrangement portion 77 is connected to the passages 84 and 85. Also, a part of the three cords 52, 55, and 61 in the length direction is arranged across the passages 84 and 85 and the arrangement portion 77. As shown in FIG. 5 and FIG. 8, when the second component 66 is separated from the first component 65 and the user sees the opening 72, the passage 85 and the arrangement portion 77 are invisible due to the presence of the holder 73.

The positional relationship of the elements arranged inside the housing 11 and the gear case 12 will be described with reference to FIG. 1. The intermediate shaft 33, the cylinder 13, the gear 44, and the conversion unit 42 are arranged in the second housing chamber 26. The partition wall 25 is arranged between the first housing chamber 18 and the second housing chamber 26 in the direction along the rotation center line A1. The electric motor 14 is arranged between the partition wall 25 and the positioning portion 73 in the direction along the rotation center line A1.

Further, the housing 11 has a wall 80 located opposite to the gear case 12 in the direction along the rotation center line A1. The wall 80 is provided by an edge 81 of the first component 65 and an edge 82 of the second component 66 abutting each other shown in FIG. 5 and FIG. 8. Further, the positioning portion 73 is arranged between the commutator 24 and the wall 80 in the direction along the rotation center line A1. Also, the arrangement portion 77 is provided outside the positioning portion 73 in the radial direction about the rotation center line A1.

Then, as shown in FIG. 6, a part of the three cords 52, 55, and 61 in the length direction is arranged in the arrangement portion 77. Namely, in the direction along the rotation center line A1, the arrangement region of a part of the three cords 52, 55, and 61 in the length direction is in the arrangement region of the positioning portion 73. Therefore, it is possible to prevent the size of the housing 11 from increasing in the direction along the rotation center line A1.

Further, when assembling the housing 11, the first component 65 can be unitized in a state where a part of the three cords 52, 55, and 61 in the length direction is passed between the rib 76A and the rib 76B and between the rib 76C and the rib 76D and is arranged in the arrangement portion 77. Then, after bringing the first component 65 and the second component 66 into contact with each other, the first component 65 and the second component 66 can be fixed by the screw members 78. Therefore, it is possible to prevent at least a part of the three cords 52, 55, and 61 from being sandwiched between the first component 65 and the second component 66. Further, since the ribs 76A, 76B, 76C, and 76D are provided, it is possible to ensure the strength of the positioning portion 73.

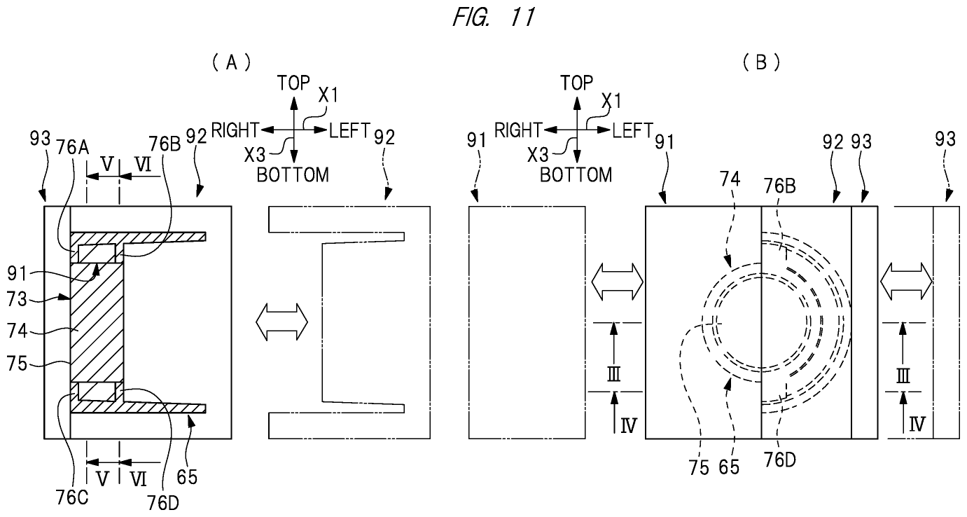

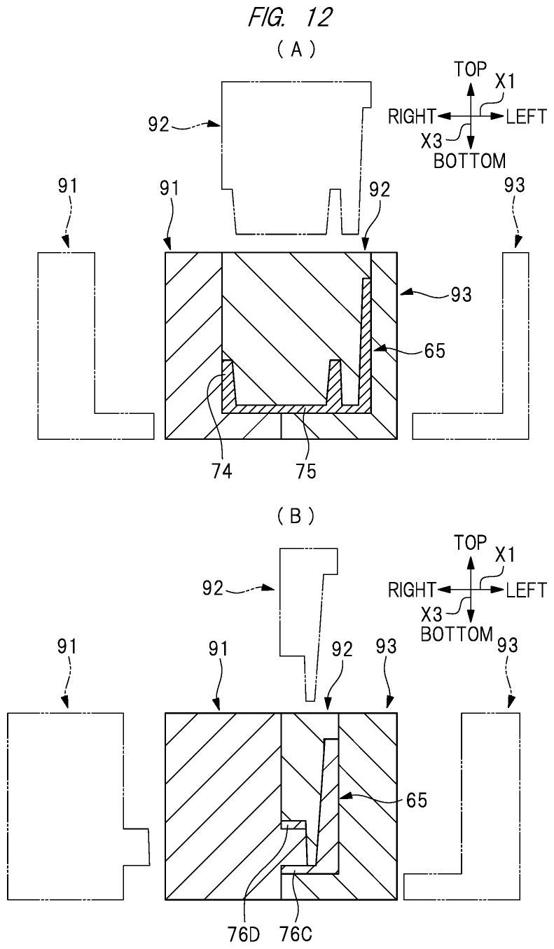

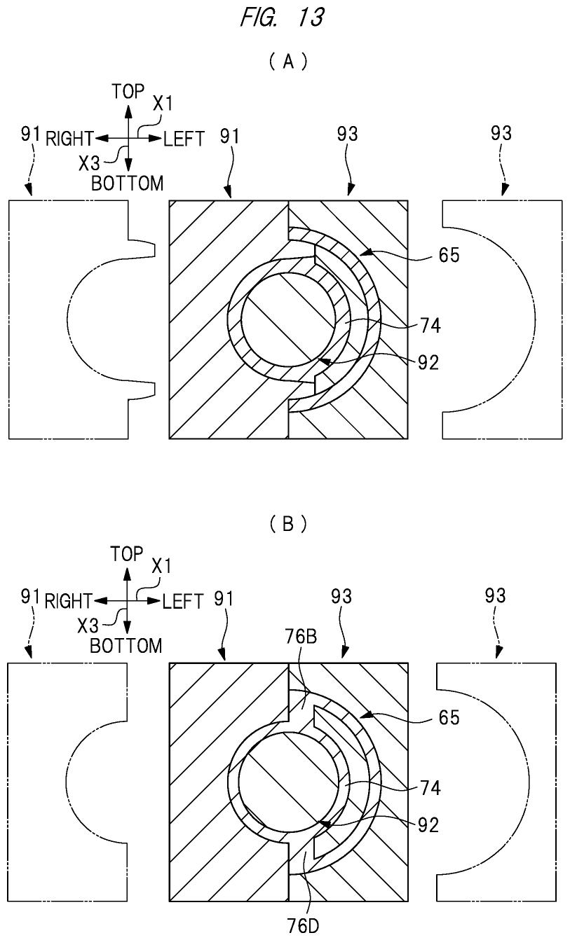

A molding die for producing the first component 65 is shown in FIG. 11(A), FIG. 11(B), FIG. 12 (A), FIG. 12(B), FIG. 13(A), and FIG. 13(B). A molding die 90 has cores 91 and 92 and a cavity 93. The core 91 is movable in the right-left direction in FIG. 12(A). The core 92 is movable in the vertical direction in FIG. 12(A). The vertical direction in FIG. 12(A) corresponds to the direction along the rotation center line A1 in the first component 65 in FIG. 6. The cavity 93 is movable in the left-right direction in FIG. 12(A).

After stopping the cores 91 and 92 and the cavity 93 so as to come close to each other, a resin material in a fluid state is injected into the space partitioned by the cores 91 and 92 and the cavity 93, and then the resin material is solidified. Thereafter, the cores 91 and 92 and the cavity 93 are separated from each other and the first component 65 is taken out.

Examples of the technical meaning of the matters disclosed in this embodiment are as follows. The hammer drill 10 is an example of an electric power tool. The rotating shaft 21 is an example of a rotating element. The electric motor 14 is an example of an electric motor. The housing 11 is an example of a housing. The cords 52, 55, and 61 are examples of electric wires. The bearing 22 is an example of a bearing. The tubular portion 74 is an example of a holder. The arrangement portion 77 is an example of an arrangement portion. The first component 65 is an example of a first component. The second component 66 is an example of a second component. The main body 67 is an example of a first main body portion. The main body 70 is an example of a second main body portion. The tubular portion 69 is an example of a tubular portion. The first housing chamber 18 is an example of a motor housing chamber.

The ribs 76A, 76B, 76C, and 76D are examples of ribs. The passages 84 and 85 are examples of holes. The passages 84 and 85 and the arrangement portion 77 are an example of a wire arrangement portion. The rotation center line A1 is an example of a rotation center line. The gear case 12 is an example of a case. The intermediate shaft 33, the cylinder 13, the gear 44, and the conversion unit 42 are an example of an actuating unit. The handle 17 is an example of a handle. The trigger is an example of an operating member. The direction along the rotation center line A1 is an example of an axial direction of the rotating element.

Further, “the housing includes a first component and a second component divided in a crossing direction intersecting an axial direction of the rotating element” means the first component 65 and the second component 66 divided in the left-right direction X1 shown in FIG. 5 and FIG. 10.

Needless to say, the electric power tool is not limited to the hammer drill disclosed in the embodiment, and can be variously changed within the range not departing from the gist thereof. For example, the electric motor may be either a brushed motor or a brushless motor. The power supply for supplying electric power to the electric motor may be either an AC power supply or a DC power supply. The DC power supply includes a battery pack that is detachably attached to the handle. The actuating unit includes at least one of a rotating element and a linearly moving element. The actuating unit includes a piston, a cylinder, a rotating shaft, a gear, and the like. The operating member includes a lever, an arm, and the like. The operating member may be either a member that can linearly reciprocate or a member that can rotate within a predetermined angle.

The holder may be divided into a first constituent piece and a second constituent piece, the first constituent piece may be connected to the first component, and the second constituent piece may be connected to the second component. In this case, it is possible to provide the wire arrangement portion at least between the first component and the first constituent piece or between the second component and the second constituent piece.

The first rotation center line of the rotating element and the second rotation center line of the electric motor may be arranged concentrically. Further, the first rotation center line and the second center line may be arranged in parallel and eccentrically to each other. Further, the first rotation center line and the second center line may be arranged so as to intersect each other.

The conversion unit that converts the rotational force of the electric motor into the linear force of the piston may be either a cam mechanism or a crank mechanism. The embodiment of the electric power tool includes a hammer driver, an impact driver, an impact wrench, a driver drill, and the like other than the hammer drill.

### REFERENCE SIGNS LIST

10 . . . hammer drill, 11 . . . housing, 12 . . . gear case, 13 . . . cylinder, 14 . . . electric motor, 17 . . . handle, 21 . . . rotating shaft, 22 . . . bearing, 33 . . . intermediate shaft, 42 . . . conversion unit, 44 . . . gear, 46 . . . trigger, 52, 55, 61 . . . cord, 65 . . . first component, 66 . . . second component, 67, 70 . . . main body, 69, 74 . . . tubular portion, 76A, 76B, 76C, 76D . . . rib, 77 . . . arrangement portion, 84, 85 . . . passage, A1 . . . rotation center line

1. An electric power tool comprising:
an electric motor having a rotating element rotated by electric power supplied thereto; and
a housing configured to house the electric motor therein; and
wherein the housing includes a first component and a second component divided in a crossing direction intersecting an axial direction of the rotating element,
wherein the first component has an opening that is open in the crossing direction, and
wherein the electric motor is housed between the first component and the second component in the crossing direction in a state where the second component is attached to the opening,
the electric power tool further comprising:
a holder formed integrally with the first component and configured to support the electric motor; and
a gap provided between the first component and the holder in the crossing direction.

2. The electric power tool according to claim 1, comprising:
an electric wire provided in the housing; and
a wire arrangement portion provided between the first component and the holder and having a region that is overlapped with the holder and invisible when viewed from the opening,
wherein the wire arrangement portion includes the gap and a hole which is provided between the housing and the holder and through which the electric wire is passed.

3. The electric power tool according to claim 2,
wherein a rib connecting the holder and the housing is provided so as to extend in a radial direction of the rotating element, and
wherein the hole is formed by being surrounded by the housing, the holder, and the rib.

4. The electric power tool according to claim 3,
wherein the hole is formed at two symmetrical positions about the rotation center line of the rotating element.

5. The electric power tool according to claim 1 further comprising a bearing provided in the housing and rotatably supporting the rotating element,
wherein the holder is arranged outside the bearing in a radial direction of the rotating element, and supports the bearing.

6. The electric power tool according to claim 1,
wherein the first component includes:
a tubular portion surrounding an outside of the electric motor in a radial direction of the rotating element; and
a first main body portion which is arranged on one side of the tubular portion in the axial direction of the rotating element and in which the opening is formed,
wherein the second component includes a second main body portion arranged on one side of the tubular portion in the axial direction,
the electric power tool further comprising a motor housing chamber which is formed between the first main body portion and the second main body portion and across the inside of the tubular portion and in which the electric motor is housed,
wherein the holder is connected to the first main body portion, and
wherein the gap is provided between the first main body portion and the holder.

7. The electric power tool according to claim 6,
wherein the tubular portion and the holder are arranged at different positions in the axial direction.

8. The electric power tool according to claim 1 further comprising:
a case fixed to the housing; and
an actuating unit supported by the case and actuated by a rotational force transmitted from the rotating element,
wherein the electric motor is arranged between the actuating unit and the holder in the axial direction.

9. The electric power tool according to claim 1,
wherein the housing includes a handle which is arranged along a direction intersecting the axial direction and is grasped by a user with a hand, and
wherein an operating member operated by the user for changing a rotation speed of the rotating element is provided on the handle.

10. An electric power tool comprising:
an electric motor having a rotating element rotated by electric power supplied thereto;
a housing configured to house the electric motor therein; and
an electric wire provided in the housing and configured to supply electric power to the electric motor,
wherein the housing includes a first component and a second component divided in a crossing direction intersecting an axial direction of the rotating element,
wherein the first component has an opening that is open in the crossing direction, and
wherein the electric motor is housed between the first component and the second component in the crossing direction in a state where the second component is attached to the opening,
the electric power tool further comprising:
a holder formed integrally with the first component and configured to support the electric motor; and
a wire arrangement portion provided between the first component and the holder and having a region that is overlapped with the holder and invisible when viewed from the opening.
